(19) United States
(12) Patent Application Publication
(10) Pub. No.: US 2026/0303744 A1
(43) Pub. Date: Oct. 1, 2026

(54) IMAGE FORMING DEVICE, CLEANING-RELATED INFORMATION OUTPUT METHOD, AND CLEANING-RELATED INFORMATION OUTPUT PROGRAM

(71) Applicant: KONICA MINOLTA, INC., Tokyo (JP)

(72) Inventor: Eiichi Narimatu, Tokyo (JP)

(73) Assignee: KONICA MINOLTA, INC., Tokyo (JP)

(21) Appl. No.: 19/563,110

(22) Filed: Mar. 11, 2026

(30) Foreign Application Priority Data
Mar. 25, 2025 (JP) 2025-049892

(51) Int. Cl. H04N 1/00

(52) U.S. Cl. CPC H04N 1/00909

(57) ABSTRACT

An image forming device includes: a light inputter that receives, from an image reader, light intensity at each position of the image reader when an image is read; a dirt-related information identifier that identifies dirt-related information related to dirt of the image reader based on the light intensity; a cleaning status inputter that receives input of a cleaning execution status of the dirt; a storage that stores the dirt-related information and the cleaning execution status in association with each other; and a cleaning-related information outputter that outputs cleaning-related information related to cleaning of the dirt based on the dirt-related information and the cleaning execution status.

### CROSS-REFERENCE TO RELATED APPLICATIONS

The entire disclosure of Japanese patent Application No. 2025-049892, filed on Mar 25, 2025, is incorporated herein by reference in its entirety.

### BACKGROUND OF THE INVENTION

### Technical Field

The present invention relates to a cleaning-related information output method and a cleaning-related information output program.

### Description of Related Art

An image forming device includes an inline scanner for reading an image. In the inline scanner, when a large amount of paper is passed for reading, paper powder is accumulated on a glass surface, and the paper powder causes dirt. If the inline scanner erroneously detects the dirt, an image cannot be read correctly, and a reading error occurs.

Conventionally, when the dirt of the inline scanner is detected during reading, a method has been proposed in which a portion of the dirt and a cleaning method are specified, and an abnormality report is printed out. Then, an operator refers to the abnormality report, prevents the inline scanner from being exposed, and cleans the inline scanner.

### Prior Art Document

### Patent Literature

Patent Literature 1: JP2002-320077A

In the conventional method described above, since the operator cannot grasp the degree of dirt or a cleaning location before cleaning the inline scanner, it has been difficult to remove the dirt of the inline scanner with one cleaning. This resulted in the inefficient process of repeatedly cleaning the inline scanner and scanning the images.

An object of the present invention is to provide a cleaning-related information output method and a cleaning-related information output program capable of making cleaning of an inline scanner efficient.

### SUMMARY OF THE INVENTION

To achieve the abovementioned object, according to an aspect of the present invention, an image forming apparatus reflecting one aspect of the present invention comprises: a light inputter that receives, from an image reader, light intensity at each position of the image reader when an image is read; a dirt-related information identifier that identifies dirt-related information related to dirt of the image reader based on the light intensity; a cleaning status inputter that receives input of a cleaning execution status of the dirt; a storage that stores the dirt-related information and the cleaning execution status in association with each other; and a cleaning-related information outputter that outputs cleaning-related information related to cleaning of the dirt based on the dirt-related information and the cleaning execution status.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing an overall configuration of an image forming system according to an embodiment.

FIG. 2 is a block diagram showing a configuration of the image forming device according to the embodiment.

FIG. 3 is a graph showing an example of a reading result of an image reader.

FIG. 4 is a graph showing an example of a reading result of the image reader.

FIG. 5 is a diagram showing an example of a cleaning status input screen.

FIG. 6 is a diagram showing an example of a mode selection screen.

FIG. 7 is a diagram showing an example of a data structure of dirt level information.

FIG. 8 is a diagram showing an example of a data structure of a dirt profile.

FIG. 9 is a graph showing an example of a reading result of the image reader.

FIG. 10 is a diagram showing a first example of a cleaning-related information screen.

FIG. 11 is a diagram explaining highlighting display on the cleaning-related information screen.

FIG. 12 is a diagram showing a second example of the cleaning-related information screen.

FIG. 13 is a diagram showing a third example of the cleaning-related information screen.

FIG. 14 is a flowchart showing an operation of the image forming device.

### DETAILED DESCRIPTION

Hereinafter, one or more embodiments of the present invention will be described with reference to the drawings. However, the scope of the invention is not limited to the disclosed embodiments.

Embodiments of the present invention will be described below with reference to the drawings. However, each embodiment described below is for embodying the technical idea of the present invention, and the present invention is not limited to the following unless otherwise specified. In addition, the same means are denoted by the same reference numerals, and description thereof may be omitted.

### Overall Configuration of Image Forming System

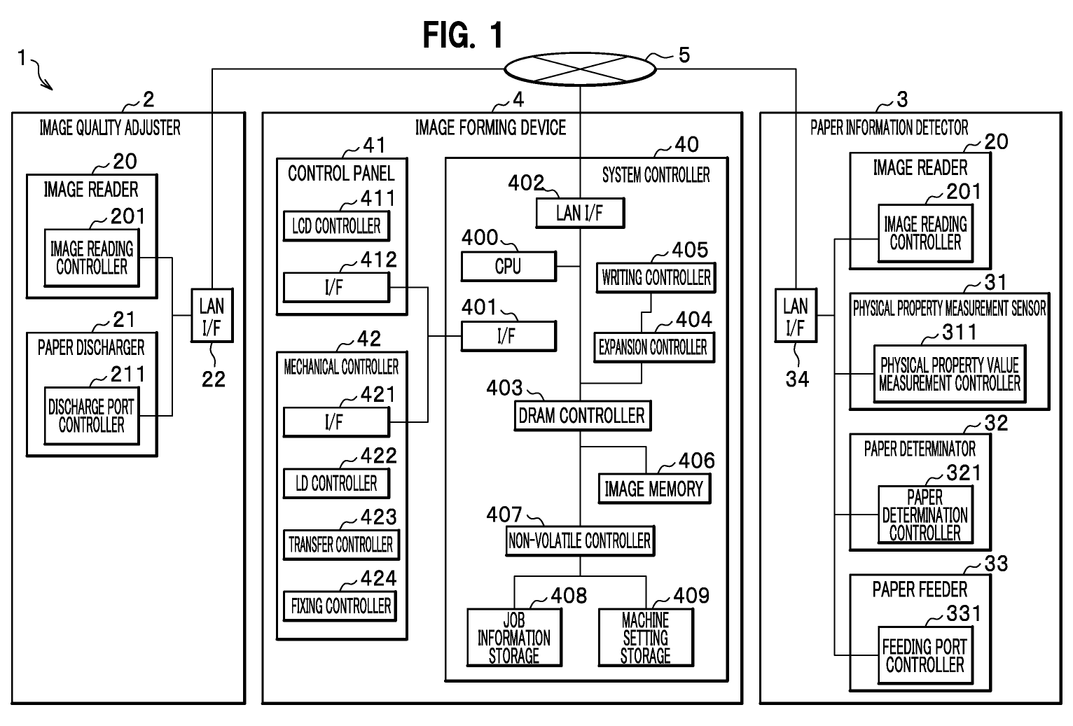

FIG. 1 is a diagram showing an overall configuration of an image forming system 1 according to the embodiment. As shown in FIG. 1, the image forming system 1 includes an image quality adjuster 2, a paper information detector 3, and an image forming device 4. Note that the image forming system 1 does not necessarily require both the image quality adjuster 2 and the paper information detector 3, and may include at least one of them.

Paper is a recording medium to be printed. For example, the paper includes printing paper, thick paper, multilayer media such as roll paper, and an OHP (Overhead Projector) sheet.

The image quality adjuster 2 adjusts an image quality of the passed paper. The image quality adjuster 2 includes an image reader 20, a paper discharger 21 that switches a paper discharge destination to a normal discharge tray or an abnormal discharge tray, and a LAN interface 22.

The image reader 20 is an inline scanner that reads an image of paper, and includes an image reading controller 201 that controls the inline scanner. The image reader 20 measures light intensity with a sensor such as a CCD (Charge Coupled Device) during a shading operation, and outputs the measured light intensity to the image forming device 4 as a reading result.

The paper discharger 21 includes a discharge port controller 211 that performs control to switch the paper discharge tray. The LAN interface 22 is an interface that connects the image quality adjuster 2 to a LAN (Local Area Network) 5. In the image forming system 1, the image quality adjuster 2, the paper information detector 3, and the image forming device 4 are connected via the LAN 5.

The paper information detector 3 detects a physical property value of the passed paper and outputs the physical property value to the image forming device 4. The paper information detector 3 includes the image reader 20, a physical property measurement sensor 31 that measures the physical property value of the paper, a paper determinator 32 that determines paper information, a paper feeder 33 that feeds the paper, and a LAN interface 34.

The physical property measurement sensor 31 includes a physical property value measurement controller 311 that performs control to measure the physical property value of the paper. The paper determinator 32 includes a paper determination controller 321 that controls determination of the paper information. The paper feeder 33 includes a feeding port controller 331 that performs control to switch a paper feeding tray. The LAN interface 34 is an interface that connects the paper information detector 3 to the LAN 5.

The image forming device 4 is an intermediate transfer type color image forming device using electrophotographic process technology. The image forming device 4 primary-transfers toner images of respective colors of Y (yellow), M (magenta), C (cyan), and K (black) formed on a photosensitive drum to an intermediate transfer belt. The image forming device 4 forms a toner image by superimposing the toner images of four colors on the intermediate transfer belt and then secondary-transferring the superimposed toner images onto the paper.

The image forming device 4 includes a system controller 40 that controls job information, a control panel 41 on which a user performs various operations, and a mechanical controller 42 that controls LD, transfer, and fixing of the image forming device 4. For example, the job information includes paper settings, image information, and page information.

The system controller 40 includes a CPU 400, an interface 401, a LAN interface 402, a DRAM controller 403, an expansion controller 404, a writing controller 405, an image memory 406, a non-volatile controller 407, a job information storage 408, and a machine setting storage 409.

The CPU 400 is a central processing unit of the image forming device 4. The interface 401 is an interface that inputs and outputs data to and from the control panel 41 and the mechanical controller 42. The LAN interface 402 is an interface that connects the image forming device 4 to the LAN 5.

The DRAM controller 403 controls compression processing of image data and expansion processing of compressed image data by the expansion controller 404. The DRAM controller 403 performs input/output control to the image memory 406. The expansion controller 404 performs expansion processing on the compressed image data. The writing controller 405 generates printed image data for image formation based on the image data input from the DRAM controller 403.

The image memory 406 is composed of a DRAM (Dynamic Random Access Memory) and has a compression memory and a page memory. The compression memory is a memory for storing compressed image data. The page memory is a memory for temporarily storing image data for print output or temporarily storing image data before compression.

The non-volatile controller 407 controls input and output to the job information storage 408 and the machine setting storage 409. The job information storage 408 is a non-volatile memory that stores the job information. The machine setting storage 409 is a non-volatile memory that stores various settings related to the image forming device 4.

The control panel 41 includes an LCD controller 411 and an interface 412. The LCD controller 411 controls an LCD (Liquid Crystal Display) touch panel that receives operations from the user. The LCD controller 411 displays various screens and notifications to the user on the touch panel. Further, the LCD controller 411 displays a software keyboard for the user to input characters on the touch panel and receives the input. The interface 412 is an interface that inputs and outputs data to and from the system controller 40 and the mechanical controller 42.

The mechanical controller 42 includes an interface 421, an LD controller 422, a transfer controller 423, and a fixing controller 424. The interface 421 is an interface that inputs and outputs data to and from the system controller 40 and the control panel 41. The LD controller 422 controls LD (writing) in the image forming device 4. The transfer controller 423 performs control when the toner image formed on the photosensitive drum is transferred to the paper. The fixing controller 424 performs control when the toner image formed on the paper is fixed.

### Configuration of Image Forming Device

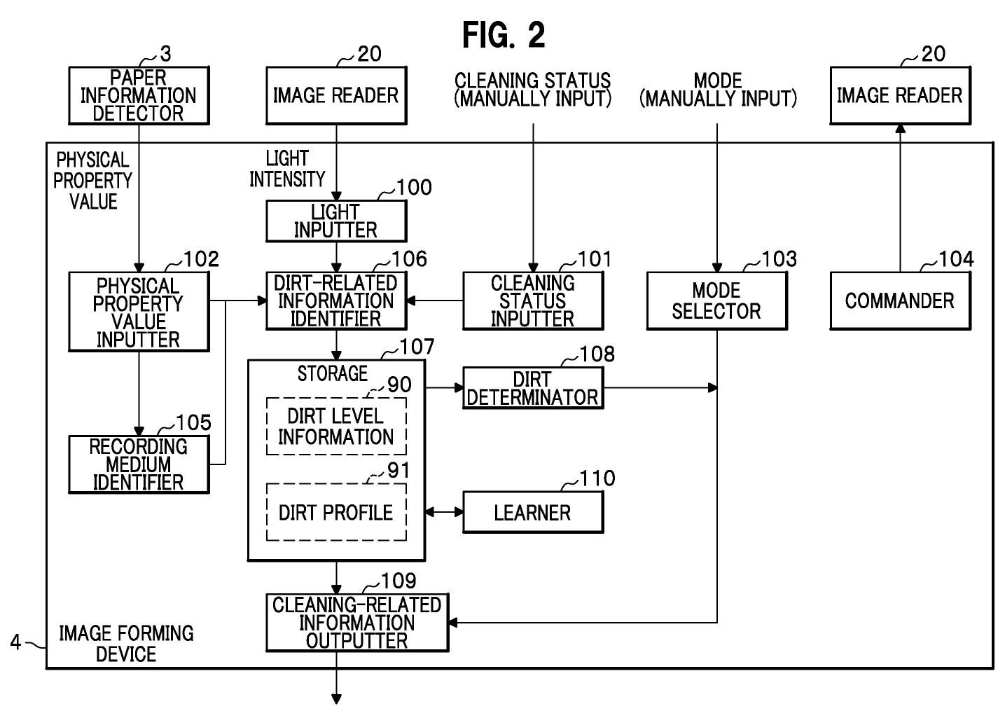

FIG. 2 is a block diagram showing a configuration of the image forming device 4 according to the embodiment. As shown in FIG. 2, the image forming device 4 includes a light inputter 100, a cleaning status inputter 101, a physical property value inputter 102, a mode selector 103, a commander 104, a recording medium identifier 105, a dirt-related information identifier 106, a storage 107, a dirt determinator 108, a cleaning-related information outputter 109, and a learner 110.

The light inputter 100 receives input of light intensity at each position of the image reader 20 when an image is read, from the image reader 20. For example, the light inputter 100 receives input of the light intensity, which is a reading result of the image reader 20, from the image reader 20 provided in at least one of the image quality adjuster 2 and the paper information detector 3. For example, when dust is attached to the image reader 20 of the image quality adjuster 2, the reading result from the image quality adjuster 2 is used. On the other hand, when dust is attached to the image reader 20 of the paper information detector 3, the reading result from the paper information detector 3 is used. The light inputter 100 outputs the input light intensity to the dirt-related information identifier 106.

### Reading Result of Image Reader

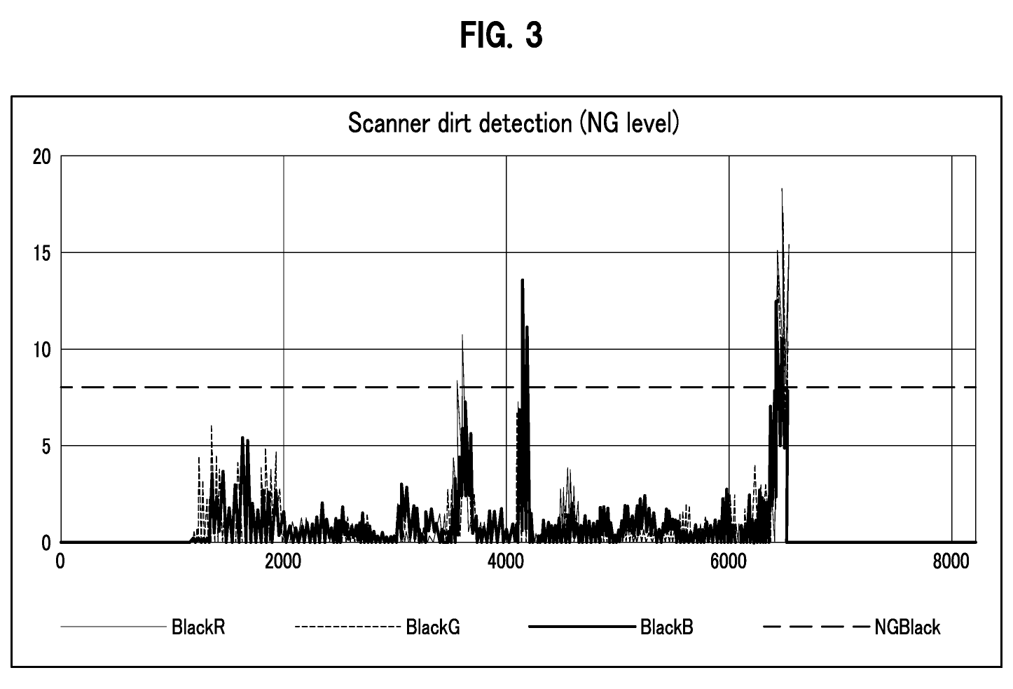

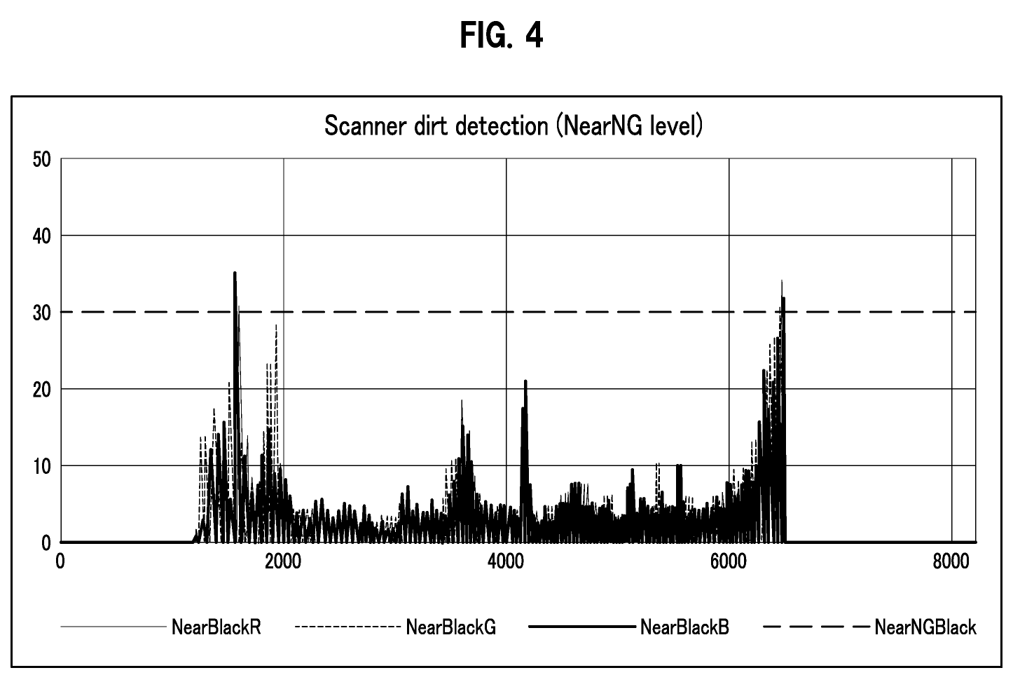

FIG. 3 and FIG. 4 are graphs showing an example of the reading result of the image reader 20. In FIG. 3 and FIG. 4, the vertical axis represents the light intensity measured by the image reader 20, and the horizontal axis represents a position when the light intensity is measured. In this horizontal axis, the right side is the back side in the main scanning direction of the image reader 20, and the left side is the front side in the main scanning direction of the image reader 20.

When dust is attached to the reading surface of the image reader 20, light is reflected before a reflecting mirror by the dust. As a result, as shown in FIG. 3 and FIG. 4, when the image reader 20 is dirty, the light intensity measured by the image reader 20 becomes strong.

Returning to FIG. 2, the description of the image forming device 4 will be continued. A cleaning execution status of the dirt is input to the cleaning status inputter 101. The cleaning execution status represents a cleaning area, the number of cleanings, and a cleaning manner. The cleaning status inputter 101 displays a cleaning status input screen for inputting the cleaning execution status on the control panel 41, and causes the user to input the cleaning execution status. For example, consider a case where the user cleans the image reader 20 and closes a front door. In this case, since a front door sensor of the image forming device 4 detects that the front door is closed, the cleaning status inputter 101 displays the cleaning status input screen.

### Cleaning Status Input Screen

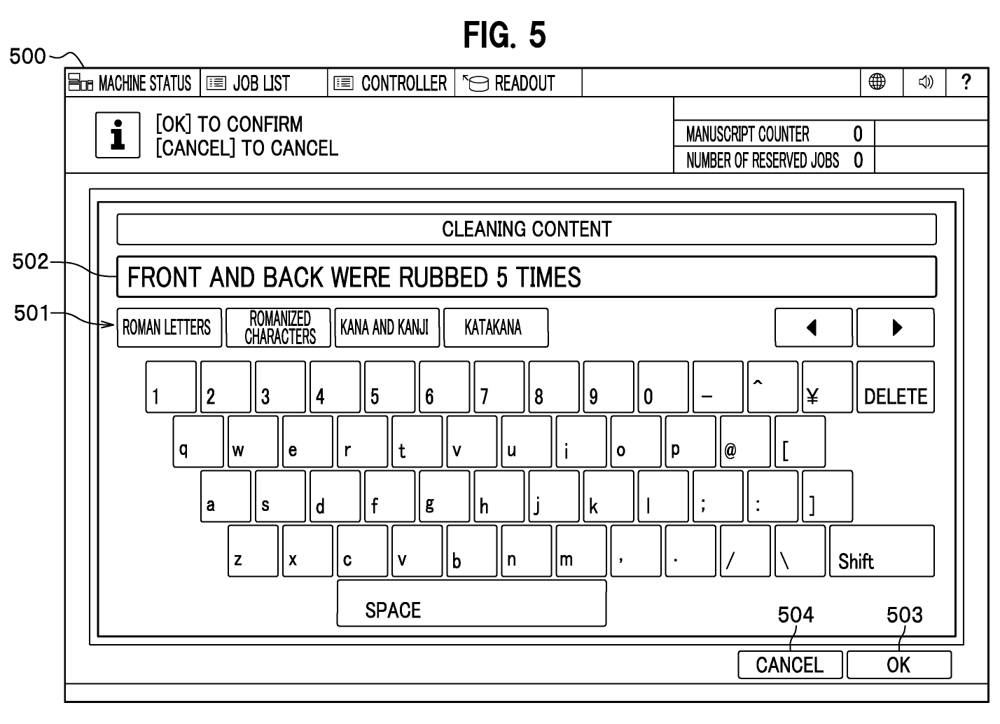

FIG. 5 is a diagram showing an example of a cleaning status input screen 500. As shown in FIG. 5, the cleaning status input screen 500 includes a software keyboard 501, a display area 502, an OK button 503, and a cancel button 504. The software keyboard 501 is a keyboard displayed on the control panel 41. The user can input the cleaning execution status by touching each button of the software keyboard 501. The display area 502 is an area for displaying the cleaning execution status input by the user. The OK button 503 is a button for the user to confirm input of the cleaning execution status. The cancel button 504 is a button for the user to cancel input of the cleaning execution status.

In the example of FIG. 5, the user inputs the cleaning execution status "front and back were rubbed 5 times". In this case, the cleaning area is "front and back", the number of cleanings is "5 times", and the cleaning manner is "rubbed". When the user touches the OK button 503, the cleaning status input screen 500 is closed, and the cleaning execution status is input to the cleaning status inputter 101. Thereafter, the cleaning status inputter 101 outputs the cleaning execution status input from the user to the dirt-related information identifier 106.

Returning to FIG. 2, the description of the image forming device 4 will be continued. The physical property value of the paper is input to the physical property value inputter 102. Specifically, the physical property value inputter 102 receives input of the physical property value from the paper information detector 3. Further, the user may manually input the physical property value to the physical property value inputter 102. For example, the physical property value of the paper includes basis weight, thickness, and a paper surface. The physical property value inputter 102 outputs the input physical property value to the recording medium identifier 105 and the dirt-related information identifier 106.

The mode selector 103 selects one of an image quality priority mode and a productivity priority mode. The image quality priority mode is a mode for detecting dirt with priority given to image quality. The productivity priority mode is a mode for detecting dirt with priority given to printing speed. The mode selector 103 displays a mode selection screen for selecting a mode on the control panel 41, and causes the user to select the mode. The mode selector 103 outputs the selected mode to the cleaning-related information outputter 109.

### Mode Selection Screen

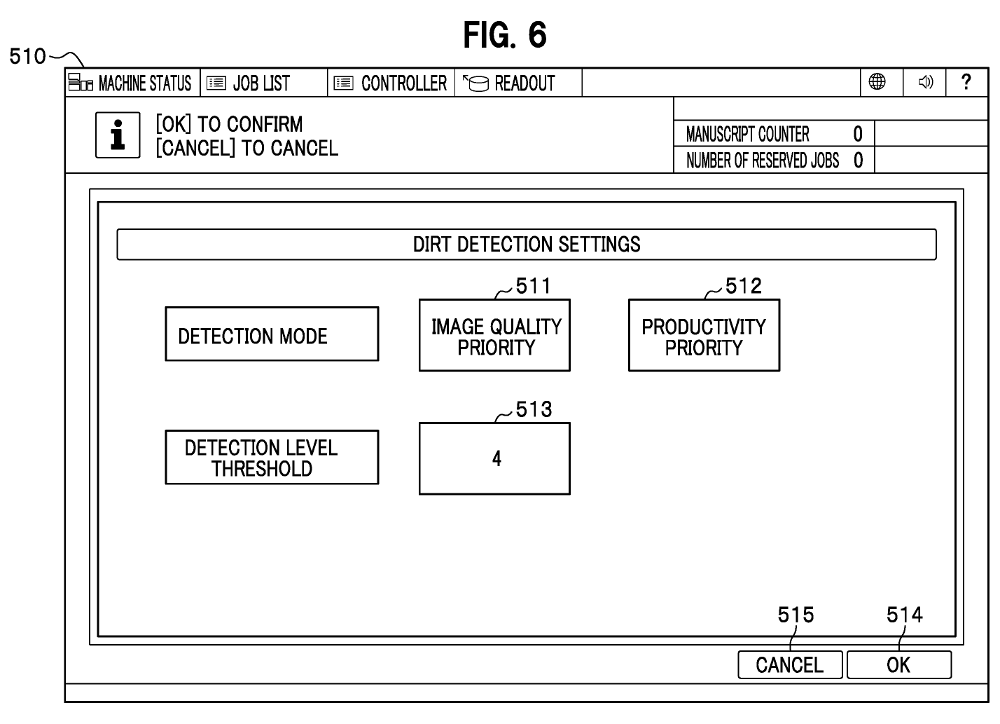

FIG. 6 is a diagram showing an example of a mode selection screen 510. As shown in FIG. 6, the mode selection screen 510 includes an image quality priority button 511, a productivity priority button 512, a detection level threshold input area 513, an OK button 514, and a cancel button 515.

The image quality priority button 511 is a button for selecting the image quality priority mode. The productivity priority button 512 is a button for selecting the productivity priority mode. When the user selects one of the image quality priority button 511 and the productivity priority button 512, selection of the other is automatically canceled.

In the detection level threshold input area 513, the user inputs a detection level threshold. The detection level threshold is a threshold of a dirt level for requesting cleaning when the productivity priority mode is selected. The OK button 514 is a button for the user to confirm selection of the mode. The cancel button 515 is a button for the user to cancel selection of the mode.

Returning to FIG. 2, the description of the image forming device 4 will be continued. The commander 104 commands the image reader 20 to irradiate the paper with light before cleaning and after cleaning. That is, the commander 104 commands the image reader 20 to execute shading. Note that the timing before cleaning and after cleaning may be manually input by the user, or the timing of cleaning may be determined by opening and closing of the front door. In response to the command from the commander 104, the image reader 20 executes shading before cleaning and after cleaning. Then, the first light intensity before cleaning and the second light intensity after cleaning are input to the light inputter 100.

The recording medium identifier 105 identifies the type of the paper based on the physical property value input from the physical property value inputter 102. For example, a table defining a correspondence relationship between the physical property value (for example, basis weight, thickness, paper surface) and the type of paper is preset in the recording medium identifier 105. Then, the recording medium identifier 105 refers to the table and outputs the type of paper corresponding to the physical property value input from the physical property value inputter 102 to the dirt-related information identifier 106.

The dirt-related information identifier 106 identifies dirt-related information related to dirt of the image reader 20 based on the light intensity input from the light inputter 100. Further, the dirt-related information identifier 106 associates the light intensity, the cleaning execution status input from the cleaning status inputter 101, the physical property value input from the physical property value inputter 102, and the type of paper input from the recording medium identifier 105 with each other, and writes them into the storage 107. The storage 107 stores dirt level information 90 and a dirt profile 91.

### Dirt Level Information

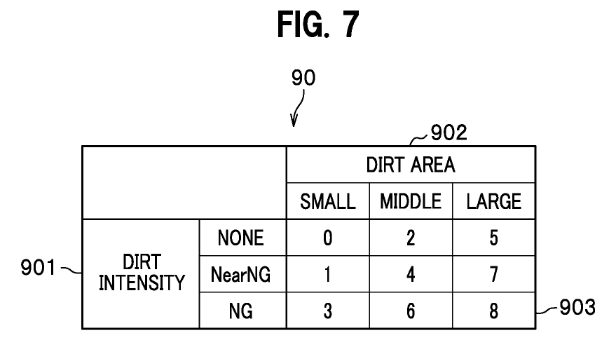

FIG. 7 is a diagram showing an example of a data structure of the dirt level information 90. As shown in FIG. 7, the dirt level information 90 is a table in which a dirt level 903 is defined based on a dirt intensity 901 and a dirt area 902.

The dirt intensity 901 represents intensity of the light intensity input to the light inputter 100. NG represents being dirty, and NearNG represents being close to dirt. A case where the light intensity is less than a threshold of NearNG is set to "none", a case where the light intensity is equal to or higher than the threshold of NearNG and less than a threshold of NG is set to "NearNG", and a case where the light intensity is equal to or higher than the threshold of "NG" is set to "NG". Note that the threshold of NG and the threshold of NearNG are manually set by the user.

The dirt area 902 represents a size of each area where the dirt intensity is "none", "NearNG", and "NG". That is, in the graphs of FIG. 3 and FIG. 4, the dirt area 902 is the size of the horizontal area where the light intensity exceeds NearNG in the main scanning direction.

In the dirt level information 90, the dirt level 903 is defined according to a combination of the dirt intensity 901 and the dirt area 902. The dirt level increases as the dirt intensity becomes stronger and the dirt area becomes larger. On the other hand, the dirt level decreases as the dirt intensity becomes weaker and the dirt intensity becomes smaller. In the example of FIG. 7, the dirt level 903 is represented by a numerical value of "0" to "9".

The dirt-related information identifier 106 refers to the dirt level information 90, obtains the dirt area and the dirt intensity from the light intensity of the image reader 20, and obtains the dirt level according to the dirt area and the dirt intensity. The light intensity, the dirt area, the dirt intensity, and the dirt level of the image reader 20 are collectively defined as dirt information.

Here, the dirt-related information identifier 106 identifies the dirt information after executing shading, that is, the dirt-related information identifier 106 obtains the dirt information before cleaning based on the light intensity before cleaning, and obtains the dirt information and the dirt level after cleaning based on the light intensity after cleaning.

### Dirt Profile

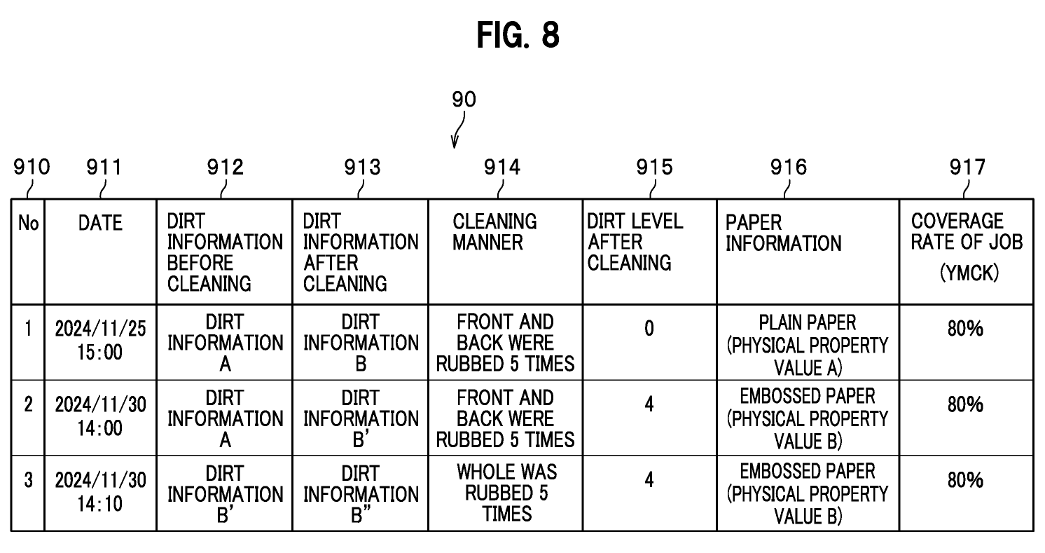

FIG. 8 is a diagram showing an example of a data structure of the dirt profile 91. The dirt profile 91 is information in which the dirt-related information and the cleaning execution status are associated with each other. As shown in FIG. 8, the dirt profile 91 includes No 910, a date 911, a dirt information before cleaning 912, a dirt information after cleaning 913, a cleaning manner 914, a dirt level after cleaning 915, a paper information 916, and a coverage rate of job 917.

The No 910 is identification information assigned to each record of the dirt profile 91. In the example of FIG. 8, the dirt profile 91 has three records, and identification information "1" to "3" are assigned to each record.

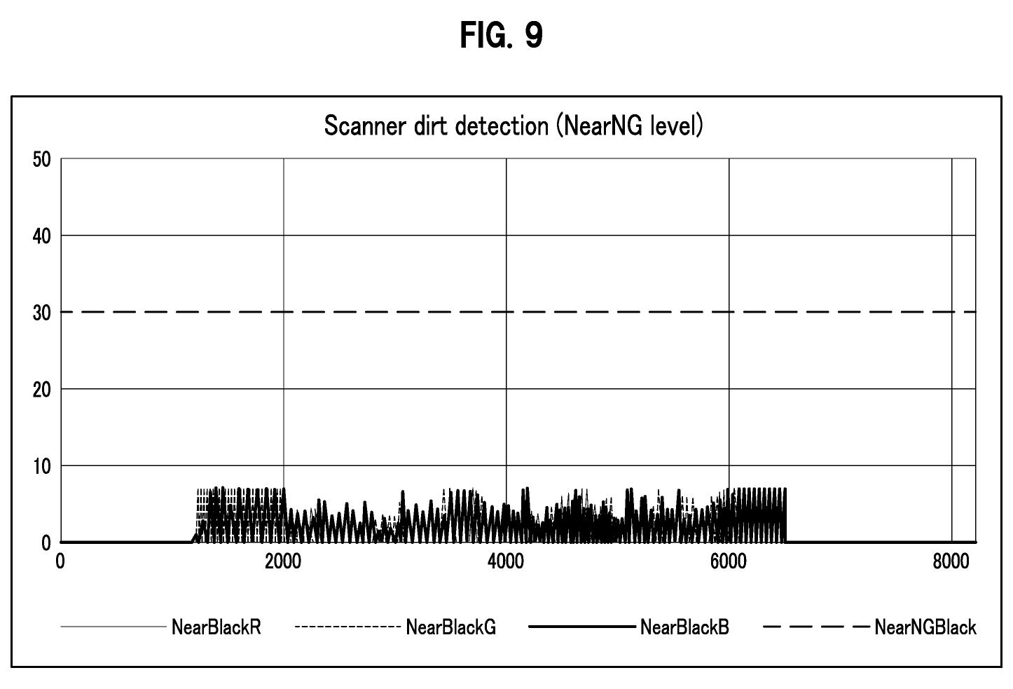

The date 911 represents a date when the dirt information before cleaning 912 at the time of creating the dirt profile 91 was acquired. The dirt information before cleaning 912 represents dirt information before the user performs cleaning. For example, dirt information A represents the graph of FIG. 3, and dirt information B' represents the graph of FIG. 4. The dirt information after cleaning 913 represents dirt information after the user performs cleaning. For example, dirt information B represents the graph of FIG. 9. FIG. 9 is a graph showing an example of the reading result of the image reader 20. As shown in FIG. 9, in the dirt information B, the light intensity is less than the threshold of NearNG at all positions, representing that the dirt has been cleaned. The cleaning manner 914 represents the cleaning execution status input by the user.

The dirt level after cleaning 915 represents the dirt level after the user performs cleaning. The paper information 916 represents the physical property value of the paper and the type of paper. The coverage rate of job 917 represents a ratio of a toner printing area to the paper. For example, when the entire surface of the paper is printed in black, the coverage rate of job 917 becomes 100%.

In the first record, since the dirt level after cleaning is "0", it is shown that the dirt could be completely removed. Here, when the dirt information after cleaning 913 at a certain date and time is identical to the dirt information before cleaning 912 at the next date and time, it can be said that the cleaning operations are related. The dirt information after cleaning 913 of the second record is "dirt information B'", which is identical to the dirt information before cleaning 912 of the third record. That is, there is a relationship between the second and third cleaning operations. In the second record, since the dirt level after cleaning is "4", it is shown that the dirt could be removed to some extent. In the third record, cleaning was further performed, but the dirt level after cleaning did not decrease from "4", representing that cleaning was not successful.

Returning to FIG. 2, the description of the image forming device 4 will be continued. The dirt determinator 108 determines presence or absence of dirt based on the dirt information. For example, the dirt determinator 108 refers to the dirt profile 91 and determines that the dirt is present when the dirt level after cleaning exceeds the detection level threshold. On the other hand, the dirt determinator 108 determines that the dirt is not present when the dirt level after cleaning is equal to or lower than the detection level threshold. The dirt determinator 108 outputs a determination result of the presence or absence of the dirt to the cleaning-related information outputter 109.

The cleaning-related information outputter 109 outputs the cleaning-related information related to cleaning of the dirt based on the dirt-related information and the cleaning execution status. The cleaning-related information outputter 109 refers to the dirt profile 91 and outputs the cleaning-related information based on the dirt-related information before and after cleaning, the cleaning manner, and the physical property value. In the present embodiment, the cleaning-related information outputter 109 displays a cleaning-related information screen on the control panel 41 as the cleaning-related information.

### Cleaning-Related Information Screen: With Cleaning Manner

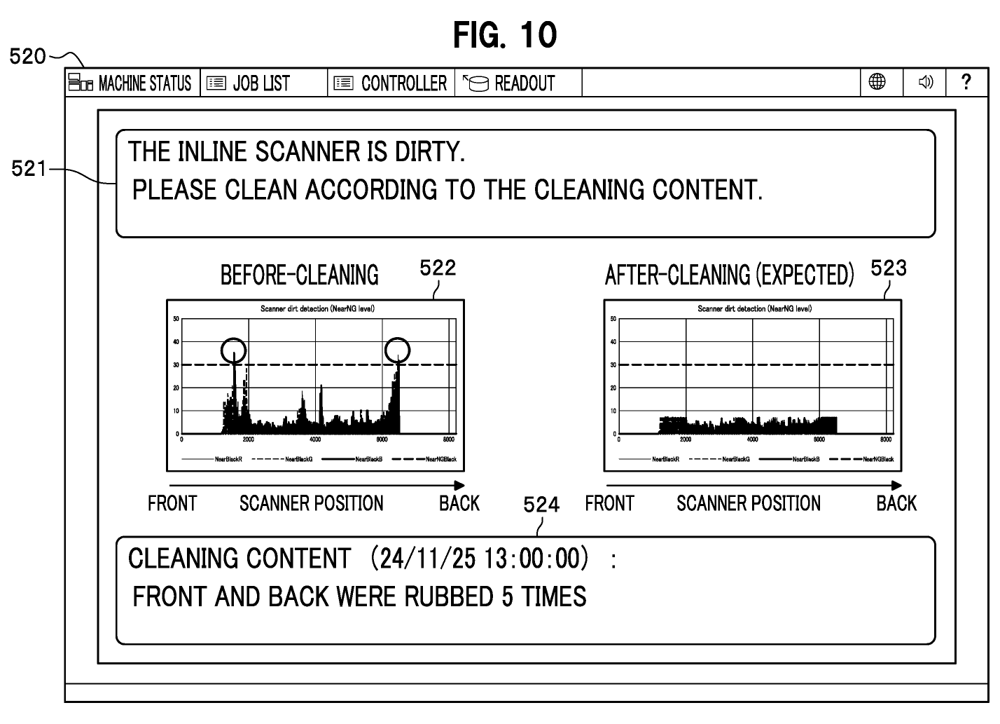

FIG. 10 is a diagram showing a first example of a cleaning-related information screen 520. The cleaning-related information screen 520 is a screen for displaying the cleaning manner. As shown in FIG. 10, the cleaning-related information screen 520 includes a cleaning request display area 521, a before-cleaning dirt information display area 522, an after-cleaning dirt information display area 523, and a cleaning manner display area 524.

The cleaning request display area 521 is an area for displaying a request for cleaning. The cleaning-related information outputter 109 requests cleaning based on the determination result of the dirt determinator 108. Specifically, when the dirt determinator 108 determines that the dirt is present, the cleaning-related information outputter 109 displays a request for cleaning in the cleaning request display area 521. In the example of FIG. 10, "The inline scanner is dirty. Please clean according to the cleaning content." is displayed in the cleaning request display area 521. Note that the cleaning-related information outputter 109 does not request cleaning when the productivity priority mode is selected on the mode selection screen 510 and the dirt level is equal to or lower than the detection level threshold.

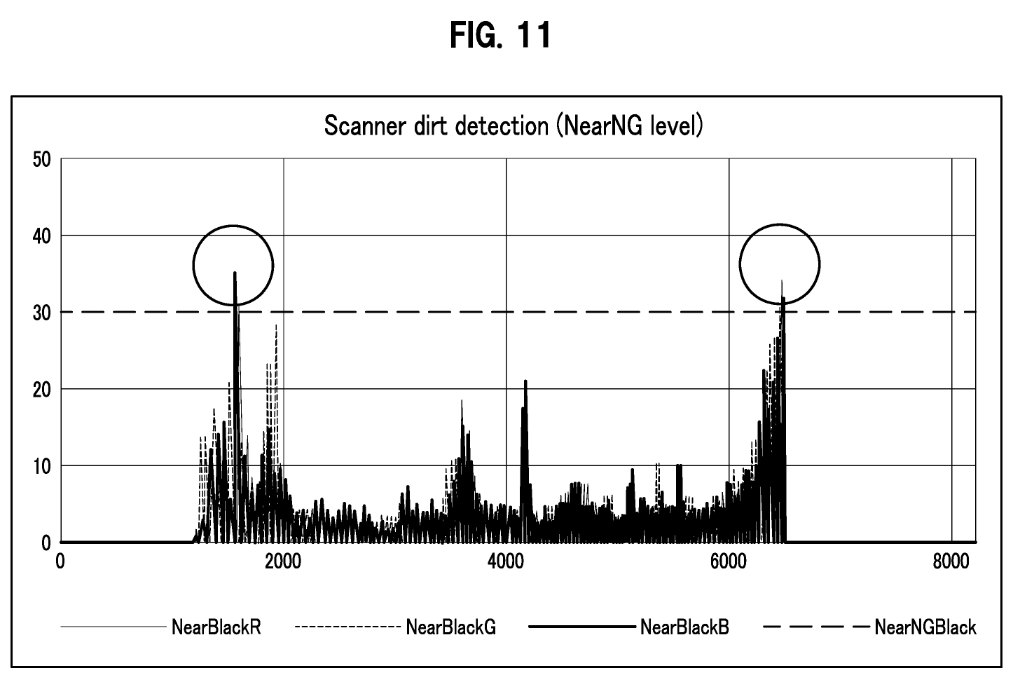

The before-cleaning dirt information display area 522 is an area for displaying the dirt information before cleaning of the dirt profile 91. For example, the graph of FIG. 11 and the threshold of NearNG for determining dirt are displayed in the before-cleaning dirt information display area 522. FIG. 11 is a diagram explaining highlighting display on the cleaning-related information screen. Further, the cleaning-related information outputter 109 highlights the dirt of a predetermined level or higher. In the example of FIG. 11, the cleaning-related information outputter 109 performs highlighting by encircling a portion that is equal to or higher than the threshold of NearNG.

The after-cleaning dirt information display area 523 is an area for displaying the dirt information after cleaning of the dirt profile 91. For example, the graph of FIG. 9 and the threshold of NearNG for determining dirt are displayed in the after-cleaning dirt information display area 523. Note that the after-cleaning dirt information display area 523 represents the dirt information after cleaning when one dirt profile is extracted from the dirt profile 91. Since the cleaning operation is not completed at the time when the cleaning-related information screen 520 is displayed, an expected result, after the cleaning operation in the cleaning manner display area 524 is performed, is displayed.

When an optimal cleaning manner exists, the cleaning-related information outputter 109 displays the cleaning manner display area 524. For example, the cleaning-related information outputter 109 extracts a dirt profile similar to the expected result of the after-cleaning dirt information display area 523 from the dirt profile 91, and sets the cleaning manner when the dirt level after cleaning 915 is minimized as the optimal cleaning manner.

The cleaning manner display area 524 is an area for displaying the date and the cleaning manner of the dirt profile 91. In the example of FIG. 10, "11/25/24 13:00:00 The front and back were rubbed 5 times." is displayed.

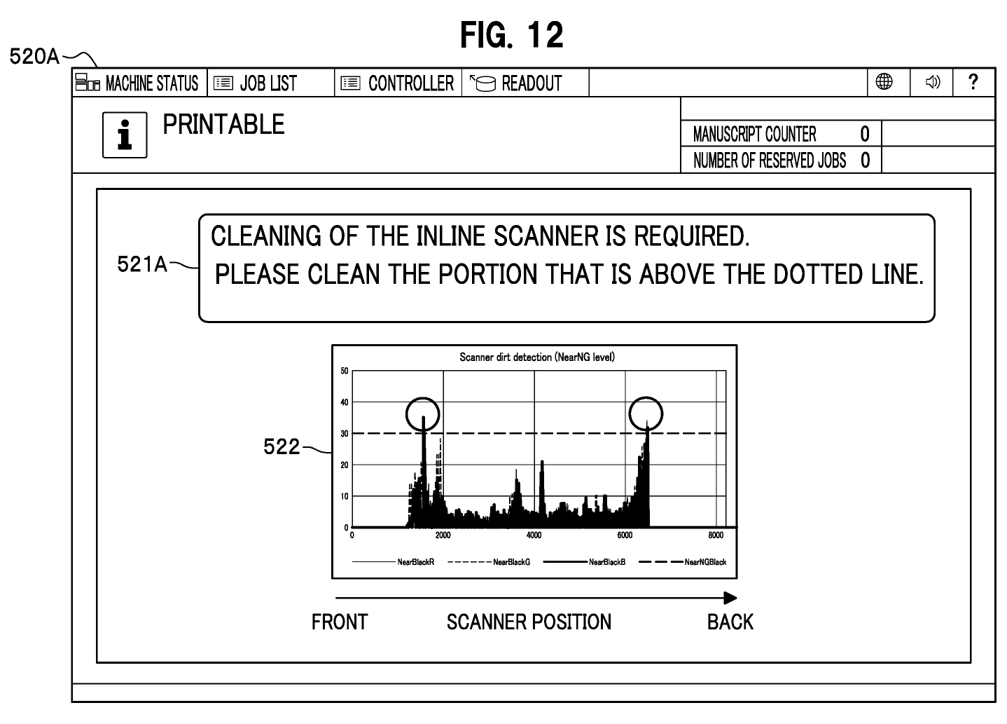

When no optimal cleaning method exists, the cleaning-related information outputter 109 does not need to display the cleaning manner display area 524. In this case, as shown in FIG. 12, the cleaning-related information outputter 109 displays a cleaning-related information screen 520A that does not display the cleaning manner.

### Cleaning-Related Information Screen: Without cleaning Manner

FIG. 12 is a diagram showing a second example of the cleaning-related information screen 520A. The cleaning-related information screen 520A includes a cleaning request display area 521A and the before-cleaning dirt information display area 522. The cleaning request display area 521A is an area for displaying a message requesting the user to clean. In the example of FIG. 12, "Cleaning of the inline scanner is required. Please clean the portion that is above the dotted line." is displayed in the cleaning request display area 521A.

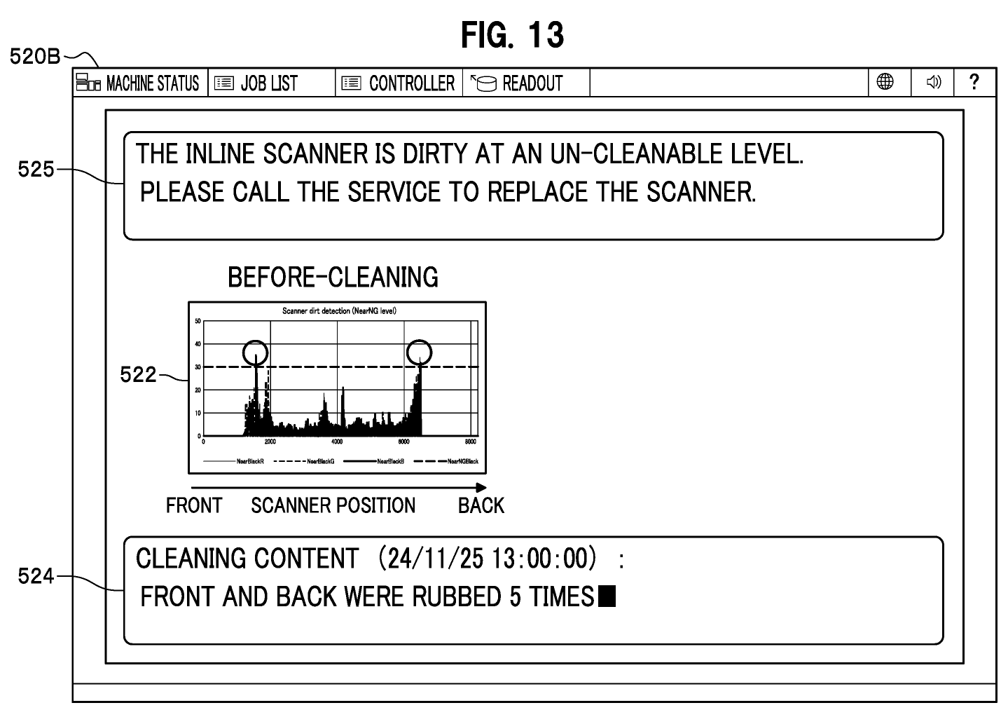

The cleaning-related information outputter 109 requests to contact the service based on the physical property value and the cleaning execution status. That is, the cleaning-related information outputter 109 requests to contact the service when cleaning fails. For example, like the third record of the dirt profile 91, when the dirt cannot be removed despite the cleaning having been performed, the cleaning-related information outputter 109 determines that the cleaning has failed. In the third record, although the re-cleaning is performed, the dirt information before cleaning is the dirt information B', and the dirt could not be removed. In this case, as shown in FIG. 13, the cleaning-related information outputter 109 displays a cleaning-related information screen 520B.

### Cleaning-Related Information Screen: Service Related Information

FIG. 13 is a diagram showing a third example of the cleaning-related information screen 520B. The cleaning-related information screen 520B includes the before-cleaning dirt information display area 522, the cleaning manner display area 524, and a service contact request display area 525. The service contact request display area 525 is an area for displaying a message requesting to contact the service. In the example of FIG. 13, "The inline scanner is dirty at an un-cleanable level. Please call the service to replace the scanner." is displayed in the service contact request display area 525.

Returning to FIG. 2, the description of the image forming device 4 will be continued. The learner 110 performs machine learning on the dirt level after cleaning corresponding to the cleaning execution status. For example, the learner 110 performs machine learning on a correspondence relationship between the cleaning execution status of the dirt profile 91 and the dirt level after cleaning. As machine learning, general deep learning can be used.

The cleaning-related information outputter 109 refers to a learning result of the learner 110 and outputs the cleaning execution status at which the dirt level after cleaning is minimized. For example, the cleaning-related information outputter 109 displays the cleaning execution status at which the dirt level after cleaning is minimized in the cleaning manner display area 524 of the cleaning-related information screen 520 of FIG. 10.

### Operation of Image Forming Device

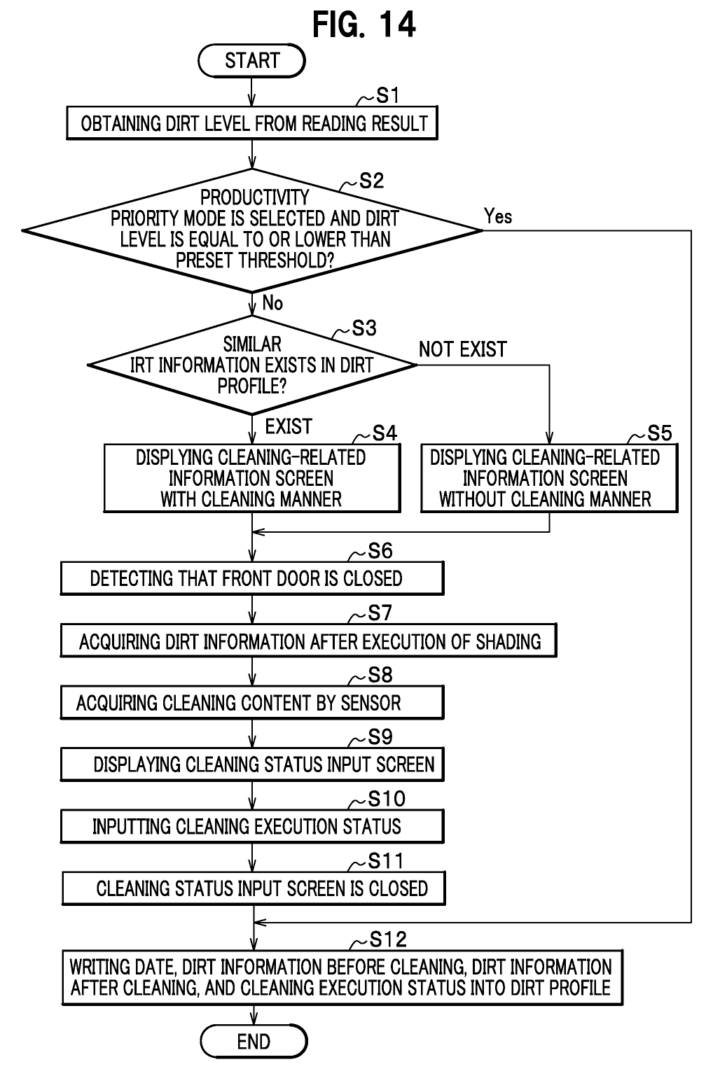

FIG. 14 is a flowchart showing an operation of the image forming device 4. As shown in FIG. 14, in step S1, the light inputter 100 receives input of the reading result of the image reader 20 after shading. The dirt-related information identifier 106 refers to the dirt level information 90 and obtains dirt information such as the dirt level from the reading result of the image reader 20.

In step S2, the cleaning-related information outputter 109 determines whether or not the productivity priority mode is selected and the dirt level is equal to or lower than a preset threshold. When the productivity priority mode is selected and the dirt level is equal to or lower than the threshold (Yes in step S2), the image forming device 4 proceeds to the processing in step S3. When the productivity priority mode is not selected or the dirt level is not equal to or lower than the threshold (No in step S2), the image forming device 4 proceeds to the processing in step S3.

In step S3, the cleaning-related information outputter 109 searches the dirt profile 91 for dirt information similar to the dirt information obtained in step S1. For example, the cleaning-related information outputter 109 obtains, as similar dirt information, a record in which a difference between the dirt information of the dirt profile 91 and the dirt information obtained in step S1 is minimized. When similar dirt information exists in the dirt profile 91 (Yes in step S3), the image forming device 4 proceeds to the processing in step S4. When similar dirt information does not exist in the dirt profile 91 (No in step S3), the image forming device 4 proceeds to the processing in step S5.

In step S4, the cleaning-related information outputter 109 displays the cleaning-related information screen 520, and proceeds to the processing in step S6. On the cleaning-related information screen 520, the cleaning manner of the dirt profile 91 searched in step S3 is displayed. In step S5, the cleaning-related information outputter 109 displays the cleaning-related information screen 520A of FIG. 12. On the cleaning-related information screen 520A, the cleaning manner of the dirt profile 91 is not displayed.

In step S6, the image forming device 4 detects that the front door is closed by the front door sensor. In step S7, the dirt-related information identifier 106 acquires the dirt information after execution of shading.

In step S8, the image forming device 4 acquires cleaning content by a sensor. In step S9, the cleaning status inputter 101 displays the cleaning status input screen 500. In step S10, the user inputs the cleaning execution status into the cleaning status inputter 101 on the cleaning status input screen 500. Thereby, on the cleaning status input screen 500, the user can input the cleaning content that could not be acquired by the sensor.

In step S11, the cleaning status inputter 101 detects that the cleaning status input screen 500 is closed. In step S12, the dirt-related information identifier 106 associates the date, the dirt information before cleaning, the dirt information after cleaning, and the cleaning execution status with each other and writes them into the dirt profile 91.

As described above, since the image forming device 4 displays the cleaning-related information, cleaning of the image reader 20 can be made efficient. That is, the image forming device 4 allows the user to grasp the dirt before and after cleaning, whereby the time required for dirt removal can be reduced. Furthermore, when the dirt cannot be removed by cleaning, the image forming device 4 prompts the user to contact the service, whereby useless cleaning operations can be reduced.

### Modification

Although the embodiments have been described in detail above, the present invention is not limited to the embodiments described above, and includes design changes and the like within a range that does not depart from the spirit of the present invention.

The cleaning-related information outputter compares the physical property value input to the physical property value inputter with the physical property value stored in the storage, and outputs the cleaning-related information based on the comparison result of the physical property values. In this way, the image forming device can determine erroneous input by the user by comparing the physical property values with each other.

In the embodiments described above, the dirt information has been described as including both the position of dirt and the intensity of dirt, but only one of the position of dirt and the intensity of dirt may be included.

In the embodiments described above, an independent hardware called an image forming device has been described, but the present invention is not limited thereto. That is, the present invention can also be realized by a cleaning-related information output program causing a hardware processor of an image forming device, which includes a light inputter that receives light intensity at each position of an image reader when an image is read, the image forming device performs: identifying dirt-related information related to dirt of the image reader based on the light intensity; receiving input of a cleaning execution status of cleaning of the dirt; storing the dirt-related information and the cleaning execution status in association with each other in a storage; and outputting cleaning-related information related to cleaning of the dirt based on the dirt-related information and the cleaning execution status.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming device comprising:
a light inputter that receives, from an image reader, light intensity at each position of the image reader when an image is read;
a dirt-related information identifier that identifies dirt-related information related to dirt of the image reader based on the light intensity;
a cleaning status inputter that receives input of a cleaning execution status of the dirt;
a storage that stores the dirt-related information and the cleaning execution status in association with each other; and
a cleaning-related information outputter that outputs cleaning-related information related to cleaning of the dirt based on the dirt-related information and the cleaning execution status.

2. The image forming device according to claim 1, wherein
the storage stores dirt information including at least one of a position and intensity of the dirt as the dirt-related information.

3. The image forming device according to claim 2, comprising
a dirt determinator that determines presence or absence of the dirt based on the dirt information, wherein
the cleaning-related information outputter requests cleaning based on a determination result of the dirt determinator.

4. The image forming device according to claim 3, wherein
the cleaning-related information outputter highlights the dirt of a predetermined level or higher.

5. The image forming device according to claim 3, comprising
a mode selector that selects one of an image quality priority mode and a productivity priority mode, wherein
the cleaning-related information outputter does not request cleaning when the productivity priority mode is selected and the dirt of a predetermined level or higher does not exist.

6. The image forming device according to claim 2, wherein
the storage stores the dirt information before cleaning, the cleaning execution status, and the dirt information after cleaning as the dirt-related information.

7. The image forming device according to claim 6, wherein
the cleaning execution status represents a cleaning area, the number of cleanings, and a cleaning manner.

8. The image forming device according to claim 6, comprising
a physical property value inputter that receives input of a physical property value of a recording medium, wherein
the storage stores the physical property value in association with the dirt-related information, and the cleaning-related information outputter outputs the cleaning-related information based on the dirt-related information, the cleaning execution status, and the physical property value.

9. The image forming device according to claim 8, wherein
the physical property value is input to the physical property value inputter from a paper information detector.

10. The image forming device according to claim 8, comprising
a recording medium identifier that identifies a type of the recording medium based on the physical property value, wherein
the storage stores the type of the recording medium in association with the dirt-related information.

11. The image forming device according to claim 8, wherein
the cleaning-related information outputter compares the physical property value input to the physical property value inputter with the physical property value stored in the storage, and outputs the cleaning-related information based on a comparison result of the physical property values.

12. The image forming device according to claim 1, comprising
a commander that commands the image reader to irradiate the recording medium with light before cleaning and after cleaning, wherein
the light inputter receives input of a first light intensity before cleaning and a second light intensity after cleaning, and
the dirt-related information identifier identifies the dirt-related information based on the first light intensity and the second light intensity.

13. The image forming device according to claim 12, wherein
the commander commands the image reader to execute shading, and
the dirt-related information identifier identifies the dirt-related information after the shading is executed.

14. The image forming device according to claim 8, wherein
the cleaning-related information outputter requests to contact a predetermined service based on the physical property value and the cleaning execution status.

15. The image forming device according to claim 14, wherein
the cleaning-related information outputter requests to contact the service when the cleaning fails.

16. The image forming device according to claim 14, comprising
a learner that performs machine learning on a dirt level after cleaning corresponding to the cleaning execution status.

17. The image forming device according to claim 16, wherein
the cleaning-related information outputter outputs the cleaning execution status at which the dirt level after cleaning is minimized.

18. A cleaning-related information output method executed by an image forming device including a light inputter that receives, from an image reader, light intensity at each position of the image reader when an image is read, the method comprising:
identifying, by a dirt-related information identifier, dirt-related information related to dirt of the image reader based on the light intensity;
receiving, by a cleaning status inputter, input of a cleaning execution status of the dirt;
storing the dirt-related information and the cleaning execution status in association with each other in a storage; and
outputting, by a cleaning-related information outputter, cleaning-related information related to cleaning of the dirt based on the dirt-related information and the cleaning execution status.

19. A non-transitory computer-readable storage medium storing a program causing a hardware processor of an image forming device, which includes a light inputter that receives light intensity at each position of an image reader when an image is read, the image forming device performs:
identifying dirt-related information related to dirt of the image reader based on the light intensity;
receiving input of a cleaning execution status of cleaning of the dirt;
storing the dirt-related information and the cleaning execution status in association with each other in a storage; and
outputting cleaning-related information related to cleaning of the dirt based on the dirt-related information and the cleaning execution status.
